(19) United States
(12) Patent Application Publication
(10) Pub. No.: US 2026/0346726 A1
(43) Pub. Date: Nov. 5, 2026

(54) CURRENT COLLECTOR HAVING SENSOR DEVICE, AND METHOD FOR OPERATION

(71) Applicants: SCHUNK TRANSIT SYSTEMS GMBH (AT), Nussdorf am Haunsberg (AT); SCHUNK TRANSIT SYSTEMS GMBH (DE), Wettenberg (DE)

(72) Inventors: Dominik Pascal ARNOLD, Heltersberg (DE); Erich BERGHAMMER, Poendorf (AT)

(21) Appl. No.: 19/112,112

(22) PCT Filed: Sep. 12, 2023
(86) PCT No.: PCT/EP2023/074972

§ 371 Date: Jan. 13, 2026

(30) Foreign Application Priority Data
Sep. 16, 2022 (DE) 10 2022 123 767.2

(51) Int. Cl. B60L 3/12; B60L 5/20; B60L 5/36

(52) U.S. Cl. CPC B60L 3/12; B60L 5/20; B60L 5/36; B60L 2200/26; B60L 2240/427; B60L 2240/429; B60L 2240/662; B60L 2240/665

(57) ABSTRACT

The invention relates to a method for operating a current collector (10, 33), a positioning device (13, 56) moving a contact strip (14, 17, 27) relative to the catenary wire and pressing it against the catenary wire into a sliding contact position using a pressing force, a drive element (73) and/or a spring element (74) of the positioning device generating the pressing force on the contact strip. The current collector has a power supply unit (50) and a measuring unit (36, 43, 53, 58) having a measuring device (38, 44, 59), at least two sensors (47, 48) of a sensor element (46) being comprised, and the power supply unit (50) yielding at least the electric energy required for supplying power to the sensor element, and the sensors each registering measured values, a processing element (37, 49) processing the measured values, the processing element correlating the measured values to each other and determining a characteristic value describing an operating state of the current collector and/or the catenary. The invention further relates to a current collector and a monitoring system.

The invention relates to a current collector and a method for operating a current collector disposed on a roof of a rail vehicle and configured for transmitting power from a catenary wire of a catenary to the rail vehicle, the current collector comprising a positioning device having a contact strip disposed thereon, the positioning device moving the contact strip relative to the catenary wire and pressing it against the catenary wire into a sliding contact position using a pressing force in order to form a sliding contact, a drive element and a spring element of the positioning device generating the pressing force to the contact strip.

Contact strips made of carbon are regularly used to supply power to both rail-bound and non-rail-bound vehicles via a catenary wire. Such contact strips are always subject to wear due to abrasion of the carbon material. When using such contact strips, for example on train locomotives, it is necessary to replace them before they reach a final wear limit in order to avoid dangerous operating conditions, defects or breakdowns. An emergency shutdown function is regularly integrated into contact strips, which causes the contact strip to be lowered when a final degree of wear is reached, or even before if the contact strip is damaged, for example, if it breaks; however, once such an emergency shutdown has been triggered, it is no longer possible to continue supplying power and therefore to continue operating the vehicle using this contact strip. To avoid such situations, contact strips are inspected at regular intervals to check their degree of wear. These inspections are carried out regularly by personnel, although this is difficult to perform as the contact strips are mounted on the roof of a vehicle, such as a locomotive, and special safety precautions must be observed due to the high voltage applied to the catenary wire. Such inspections are therefore carried out at certain intervals in railroad depots. Automated wear monitoring systems which can signal when a wear limit has been reached are known to some extent to avoid these costly inspections. For example, WO 2014/173798 A2 discloses a contact strip having a wear indicator marking which can be registered by means of an infrared camera. During a passage of the camera positioned on a track, the contact strip can be registered by the camera and the wear indicator mark can be detected by image processing. Depending on the appearance of the wear indicator mark, conclusions can now be drawn about the wear degree of the contact strip. The disadvantage here is that permanent monitoring of the wear condition of the contact strip is not possible and that a technical effort required to establish such monitoring in a rail network is comparatively high and therefore costly.

Furthermore, the positioning element can regularly include a rocker, a rocker element, an articulated element and/or a pantograph, via any of which the contact strip is pressed against the catenary wire by means of the spring element, thus applying the pressing force required to form a secure sliding contact. The spring element can be formed by an air bellows, tension and/or compression springs. Within the scope of the invention, it is also conceivable that an air bellows forms the drive element and the spring element. The spring element also compensates movements of the rail vehicle and a changing course of the catenary wire. Depending on the relative distance from a route of the rail vehicle to the catenary wire and the speed of the rail vehicle, strongly changing forces can act on the contact strip, which puts much strain on the contact strip. The contact strip itself and/or the positioning device can also be stimulated to rock. When the contact strip is lifted off the catenary wire, an electric arc can occur, which increases wear on the contact strip due to electrical burn-off. This results in an overall increased effort for maintenance of the current collector and for replacement of the contact strip, which is dependent on the condition of the catenary. It is therefore known to check track sections of catenaries during test or measurement runs with a rail vehicle. For this purpose, the specially designed rail vehicle must be equipped with specially designed measurement technology, such as cameras for capturing images of the catenary wire. Such tests are therefore cost-intensive and only allow a snapshot of the operating state of the catenary.

However, such measurement runs intended for monitoring the infrastructure, such as the catenary, are only carried out at regular intervals and are therefore carried out in a temporarily limited manner. In order to be able to regularly check maintenance-intensive components of a rail vehicle, efforts are being made to continuously monitor these components by means of sensors disposed on the rail vehicle for at least one maintenance cycle, which in the case of a pantograph can be eight years, for example. However, relatively expensive sensors, such as optical components and/or fiber sensors, are often used in generic methods. Another disadvantage of the known monitoring systems is that the data is not pre-processed locally, i.e., directly at the rail vehicle and/or in the area of the attachment part to be monitored, which means that a large amount of data has to be transmitted and processed.

In addition, individual sensors and their measured values are considered only on their own and not in combination with other measured values, in particular the measured values of different sensor types, so that the advantages of a swarm effect and/or swarm intelligence can only be used insufficiently or not at all.

A further disadvantage of known monitoring systems and monitoring methods is that they cannot be operated in an energy self-sufficient manner over the desired periods of time, in particular over several years, as the known monitoring systems require an external power supply, for example via the rail vehicle, depending on sensor technology and the location of the arrangement on the rail vehicle. This requires interventions in the rail vehicle electronics or connections to the rail vehicle electronics in a disadvantageous manner.

There therefore is a great need for a method for operating a current collector and a monitoring system using a current collector which can be operated in an energy self-sufficient manner and can reliably register and process sensor data from several sensors.

The object of the invention is therefore to propose a method for operating a current collector, a current collector and a monitoring system using a current collector, all of which enable improved operation, in particular energy self-sufficient monitoring, of the current collector.

A method for operating a current collector disposed on a roof of a rail vehicle and configured to transmit power from a catenary wire of a catenary to the rail vehicle can be carried out using a current collector, the current collector comprising a positioning device having a contact strip disposed thereon, the positioning device moving the contact strip relative to the catenary wire and pressing it against the catenary wire in a sliding contact position using a pressing force in order to form a sliding contact, a drive element and/or a spring element of the positioning device generating the pressing force to the contact strip, the current collector having a power supply unit disposed on the positioning device and a measuring unit having a measuring device, at least two sensors of a sensor element of the measuring device being disposed on the positioning device and/or the contact strip, and the power supply unit yielding at least the electric energy required for supplying power to the sensors of the sensor element, and the sensors each registering measured values in the sliding contact position.

A processing element of the measuring device can process the measured values, it being conceivable that the processing element can correlate the measured values to each other and can determine a characteristic value describing an operating state of the current collector and/or the catenary. The contact strip comprises a contact element, usually made of carbon, which can abut against a catenary wire and thereby establish an electrical connection therewith. This contact element is held by a contact strip carrier, which in turn is mounted to an articulated element, which can be designed as a so-called pantograph or rocker. This pantograph and/or the rocker together with a base frame forms a positioning device for the contact strip and thus, together with the contact strip, forms a so-called current collector. This in turn is then mounted on the roof of a vehicle, preferably above the base frame, in order to contact the catenary wire located above the vehicle. In the context of the invention, the positioning device can preferably have a base frame, an articulated element and a rocker element. The base frame can be disposed on the rail vehicle. The rocker element can carry the contact strip. The articulated element can be disposed between the base frame and the rocker element and can be articulated to the base frame and/or the rocker element. The articulated element can preferably have an upper arm and a lower arm, which are articulated to each other. The upper arm and lower arm can also be designed as upper scissors and lower scissors. The upper arm can be articulated to the rocker element and/or the lower arm can be articulated to the base frame. The articulated connection point between the upper arm and lower arm of the articulated element can also be referred to as the knee of the articulated element or the positioning device.

The positioning device can press the contact strip against the catenary wire and apply the pressing force required in order to form a secure sliding contact. The pressing force can be applied by an air bellows, tension springs and/or compression springs. However, it is also conceivable that the pressing force is applied by a motor using an electric motor and/or an actuator. In this case, it has proven to be advantageous if at least one sensor, for example a current sensor and/or a voltage sensor, is disposed on the electric motor and/or actuator and interacts with it to measure current and/or voltage. Since the electric motor and/or the actuator are regularly disposed on the potential of the rail vehicle, data can be transmitted to an evaluation unit, a processing element and/or a base unit wirelessly, preferably via Bluetooth.

The positioning device can be operated and/or controlled electrically or pneumatically and be monitored accordingly by means of voltage and current measurement (electrical) and/or by means of at least one pressure sensor (pneumatic/hydraulic).

In the method, it may be intended that the current collector comprises a measuring unit having a measuring device, which in turn has a sensor element having at least two sensors. The sensors can be disposed on the positioning device and/or the contact strip, but can in principle also be disposed anywhere on the current collector. By means of the sensor element and/or the sensors, different measured values of the positioning device and/or the contact strip can be registered in the sliding contact position. These measured values are physical measured variables which are directly operatively related to the positioning device, the contact strip or the catenary and are variable during operation of the current collector.

By means of the processing element, the measured values and/or the measured variables measured by the sensors can be processed and a characteristic value can be determined which is suitable for describing an operating state of the current collector and/or the catenary. The base unit can comprise a processing element.

Advantageously, the processing element can correlate the corresponding measured values of the sensors to each other to determine the characteristic value. This makes it possible to obtain further information in the form of the characteristic value about an operating state of the current collector and/or the catenary. The processing element can perform a calculation with at least two measured values from at least two sensors. Depending on the type of sensors, the measured values can be measured values of the same or different types. For example, a vertical movement of the positioning device can be measured using a first sensor and a vertical movement of the contact strip can be measured using a second sensor. The processing element then correlates the two measured values, for example by the processing element taking into account a relationship between the two measured values when calculating the characteristic value, such as an unevenness in a route relative to a flat catenary wire or vice versa. If a vertical movement of the contact strip and the positioning device is identical, the movement is induced by the course of the catenary wire and not by the route.

The characteristic value can be a parameterized value, a characteristic variable, a characteristic factor or a data set. The characteristic value can also be contained within a data set. In particular, the measured values are intended to be digitally processed by means of the processing element in order to obtain a characteristic value which can be further digitally processed. The processing element is therefore formed by at least one digital electronic circuit which can process analog and/or digital signals from the sensor. The processing element can, for example, also be a programmable logic controller (PLC), an integrated circuit (IC) or a computer.

The fact that the processing element can determine the characteristic value suitable for describing the operating state of the current collector and/or the catenary makes it possible to determine the operating state of the current collector and/or the catenary, to monitor it and/or to influence the operating state of the current collector. An operating state is understood to be a structural, variable property of the current collector and/or the catenary present during operation. Since the operating state of the current collector is also essentially dependent on a condition and/or an operating state of the route, the characteristic value can also describe the operating state of the route. Overall, maintenance of the current collector, the catenary and the route can thus be carried out in a targeted manner without the need to observe regular maintenance intervals or to carry out test runs with a rail vehicle. Overall, this makes it possible to operate a current collector and/or a catenary more cost-effectively, and therefore a rail vehicle more economically overall.

The power supply unit according to the invention yields the power required at least to supply power to the sensors of the sensor element directly from the current collector, meaning the measuring unit can also be operated over a longer period of time, for example several years, in an energy self-sufficient manner and no intervention in the electronics of the rail vehicle is necessary. Preferably, the power supply unit yields the power required to supply the complete measuring unit, consisting at least of the measuring device and the processing element, with power. It is conceivable that the processing element also comprises a data concentrator element and that an evaluation unit and a control device are also integrated in the measuring unit. Provided the evaluation unit, control device and/or data-concentrator element are provided on the current collector, the power supply unit preferably also yields the power required to operate the evaluation unit, control device and/or data-concentrator element. The power supply unit preferably has at least one power supply element.

As described above, a plurality of characteristic values or a group of characteristic values can be determined from the measured values of at least two sensors. For example, a model of the route traveled by the rail vehicle can be determined by evaluating a group of characteristic values and/or a fingerprint dependent on the measured values can be assigned to the track section. The determination of the fingerprint of the route traveled is based on the fact that the catenary has an individual profile at each point, the profile being able to be detected by sensors. In order to be able to reliably assign the individual profile at each location to a geo-graphical position, a position sensor, such as a GPS sensor, can be provided whose data can be linked to the profile of the catenary. It has been recognized in the context of the invention that typical components of the catenary infrastructure, such as masts, hangers, anchors, separators and/or crossings, can influence and/or generate a characteristic fingerprint of the catenary or the rail network. Thus, a characteristic fingerprint of a catenary section and/or a track section can be generated when driving over this track section or along a catenary section. Based on the unique characteristics of the catenary, a defect in the catenary can be assigned to a location of the defect after recording the fingerprint of the catenary. In particular, if the same catenary section is passed several times, it is possible to identify whether the cause of a defect is attributable to the catenary or the pantograph by comparing the measured fingerprints of the catenary section with previously measured fingerprints of the catenary section and/or a comparison with the measured values of other sensors which, for example, register measured values for the state of the current collector. It is also conceivable that the height of the catenary, both when contacted and freely suspended, can be registered and/or can be derived from the measured values as part of the registration of the fingerprint of a catenary section and/or detached from the registration of a fingerprint of a catenary section.

It is also conceivable that the characteristic value determined by means of the method according to the invention describes a wear degree of the contact strip, such as regular wear during operation and/or unintentional and/or unplanned wear, such as cutouts on the contact element. Furthermore, pressing force, lifting times and/or lowering times of the current collector can be determined. It is also conceivable that the condition of individual components of the current collector, in particular the positioning device, can be described by a characteristic value. Thus, the characteristic value can describe the operating state of a rocker, a joint guide, a pantograph and/or a spring element according to an embodiment.

In addition, it is conceivable that the characteristic value describing the operating state of the current collector and/or the catenary is determined from measured values relating to electric current and/or voltage which drops across the current collector. These measured values can be fed to the processing element, be correlated to each other by the processing element and thus a characteristic value describing an operating state of the current collector and/or the catenary can be determined.

Due to the self-sufficient design of the current collector and in particular of the measuring unit using the power supply unit disposed on the current collector, the measuring unit can be operated independently of the rail vehicle, the measuring unit preferably using wireless data transmission to transmit measured values and/or characteristic values. Therefore, the measuring unit and the power supply unit can advantageously be disposed on a current collector at a later time, i.e., be retrofitted, and operated independently of information and electrical supply from the rail vehicle. The elementary functions of a current collector are therefore not affected by the measuring unit and the power supply unit and there is no need to intervene in other components of the rail vehicle. In order to ensure this advantageous independence from the rail vehicle, the power supply unit yields at least the power required to operate the sensors of the sensor element, preferably the power required to operate the entire measuring unit. By using economical processors in conjunction with intelligent processing algorithms, the measuring unit requires on average approx. 0.5 W to 5 W, preferably only approx. 1 W on average, of electrical power. This low power consumption is negligible compared to the power transferred by the current collector.

Advantageous embodiments of the invention are the subject matter of the dependent claims. In addition, all combinations of at least two features disclosed in the description, the claims and/or the figures fall within the scope of the invention. It is to be understood that the explanations relating to the method refer in an equivalent manner to the current collector and the monitoring system according to the invention, without being mentioned separately. In particular, it is to be understood that the present disclosure includes customary linguistic transformations and/or a meaningful replacement of respective terms within the framework of customary linguistic practice, in particular the use of synonyms supported by the generally recognized linguistic literature, without being explicitly mentioned in their respective formulation.

The electrical energy required at least to power the sensors of the sensor element can be yielded by means of a first power supply element from an alternating current applied to the current collector and/or by means of a second power supply element from a direct current applied to the current collector. Preferably, the current collector has a first and a second power supply element. Advantageously, the energy self-sufficient operation of the measuring unit can then be guaranteed regardless of the type of power supply to the rail vehicle, for example this can occur via an AC or DC power supply. Thus, when operating the current collector in an AC network, the first power supply element can be used, which is also referred to as an AC power supply element in the context of the invention, and when operating the current collector in a DC network, the second power supply element, which is also referred to as a DC power supply element in the context of the invention, can be used in order to yield at least the electrical power required to supply the sensors of the sensor element with power.

The power supply unit can therefore comprise two power supply elements based on different principles and disposed on the current collector in order to ensure a self-sufficient power supply for the measuring unit when both direct current and alternating current are applied to the current collector. Preferably, a direct current power supply element (DC energy harvester) and an alternating current power supply element (AC energy harvester) are disposed on the current collector.

Provided the current collector is operated in an AC network, i.e., AC voltage is applied to the current collector, the alternating current is used within the power supply element to induce an alternating current in a toroidal coil, the alternating current being converted to a DC voltage, which can be used for the measuring unit, by means of the power supply unit and/or in a base unit of the measuring unit. To transmit the current from the catenary to the rail vehicle, the current collector can have at least one bus bar, preferably four bus bars, in a known manner. In the context of the invention, it has proven to be advantageous if, at the point at which the current is transferred from the articulated element of the current collector to the base frame by means of at least one bus bar, a bolt is disposed on the base frame, via which a toroidal coil is slid and which can be connected to the bus bar, for example by means of a cable lug. The alternating current thus flows through the bolt and also induces an alternating current in the toroidal coil, the alternating current being able to be converted to a direct voltage which can be used by the measuring unit. The bolt is preferably designed in such a manner that the current flow through the bus bars from the catenary to the rail vehicle is not impaired. It is conceivable that an AC power supply element is connected to each of the bus bars of a current collector. For example, a current collector can have four bus bars and four AC power supply elements, each of the AC power supply elements being assigned to a bus bar of the current collector.

The energy generation during operation of a current collector in direct current networks by means of the direct current power supply element is based on a voltage drop due to the resistance of the bus bars of the current collector. In the context of the invention, it has been realized that the current collector, in particular the bus bars of the current collector, have a resistance, regularly of only a few milliohms (mΩ). During operation in a direct current network, a voltage drops across this resistor due to the resistance of the current collector, depending on the electric current. This voltage can be several hundred millivolts (mV), for example. The voltage dropped across the current collector and/or the bus bars due to the resistance of the current collector and/or the bus bars can be tapped and used to supply power to the measuring unit. It has proven to be particularly advantageous if the DC power supply element comprises an electrical line which is laid along the current collector, in particular along the articulated element of the current collector from the rocker element to the base frame of the current collector. This first electrical line can be designated as a bypass line and can end, for example, in a base unit disposed on the base frame. The base unit can be contacted again with a section of a bus bar connected to the base frame of the current collector via a further, second electrical line. This results in a parallel connection of the bus bar of the current collector and the first and second electrical lines routed in parallel via the base unit. In this context, it has been realized as essential that the first electrical line routed from the rocker element of the current collector to the base unit has a higher resistance, in particular a significantly higher resistance, than the bus bar of the current collector.

The power supply unit can have a voltage converter, such as a boost converter and/or a buck converter. In addition, the power supply unit can have an energy storage device which enables a time-delayed energy output depending on the requirements of the measuring unit. As a result, the device according to the invention enables self-sufficient and high-quality monitoring of the interaction between current collector and catenary and/or catenary wire of the catenary as well as their states, which can be output as characteristic values, at low hardware costs.

An angular position of the positioning device, an acceleration, a speed, a rotation, a frequency, a temperature, an illuminance, a force, an electric current, a voltage, an electric resistance, a distance, a mass, an air pressure, a sound, wear and/or a local position can be continuously or discontinuously registered and processed as measured values. Acceleration can be easily measured using a gyro sensor. The angular position of the positioning device can be used to measure a deflection of a rocker element or a pantograph relative to the rail vehicle at a pivot point of the rocker element and/or the pantograph. For example, a rotary potentiometer at the pivot point or another suitable sensor, such as a gyro sensor for measuring an angle of inclination or rotation, can be used for this purpose. A temperature can be measured using a temperature sensor on the positioning device, and/or on a rocker element or a pantograph, or the contact strip in order to be able to determine, for example, whether there is a risk of the catenary wire becoming iced over. An illuminance can be measured using an optical sensor or a camera, which forms the sensor. This allows, for example, irregularities on a surface of the catenary wire or electric arcs to be detected. A force can be determined by means of a strain gauge, a force sensor, a pressure sensor or the like. For example, a pressing force can then be measured as a function of the air pressure of a cylinder of the positioning device. An electric current and/or a voltage can be measured using an ammeter and/or using a voltmeter as a sensor. A resistance can be determined from the electric current and voltage and can be a measure of contact quality and provide information about the wear condition of the contact strip. For example, the quality of energy transfer between the contact strip and the catenary wire can be determined. The mass can also be determined using a force sensor. An air pressure can be measured on an air bellows or a pressure cylinder for applying the pressing force. A local position of the current collector can be easily determined by a satellite navigation system, for example GPS. Sound can be measured by a microphone so that noise can be evaluated as a measured value. Wear can be measured by means of a sensor with which a height and/or thickness of a contact strip can be measured. The measured values can be detected and processed continuously. It is also possible to register and process the measured values discontinuously, for example at fixed times or on certain occasions.

It is conceivable that at least an acceleration sensor can be used as a sensor, the acceleration sensor being able to be disposed on the contact strip and/or the positioning device. The sensor can be a rotational or translational acceleration sensor and/or vibration sensor, which can be used to measure a movement and/or acceleration of the positioning device and/or the contact strip. For example, the acceleration sensor can detect a movement of the contact strip on the catenary wire, conclusions being able to be drawn from the movement regarding the shape of the catenary wire and/or the contact strip. For example, a step in the course of the catenary wire, which can cause the contact strip to lift off the catenary wire, can be easily registered. Special measuring runs or on-site inspections of the catenary to detect such defects are then no longer necessary. Furthermore, a change in the contact strip as a result of wear and/or abrasion causes a geometric change in the contact strip. This can result in a difference between a new and a worn contact strip. Since the contact strip is regularly in contact with and brushes the catenary wire while the rail vehicle is moving, the processing element can derive a change in the contact strip from a movement of the contact strip together with another measured value, for example a movement of the positioning device. It is also possible for the processing device to store movement profiles of new and worn contact strips, the processing device being able to carry out a comparison and determine the wear state and/or consumption of the contact strip. This wear can then also be output in the form of the characteristic value. In addition, breakage or deformation of the contact strip and damage to the catenary can be easily detected.

Furthermore, at least one sensor can be used which can be disposed within the contact strip, on the contract strip, on a fastening bearing of the contact strip or on a rocker element of the positioning device holding the contact strip. Consequently, the sensor can, for example, be disposed in a recess of the contact strip and/or a contact element of the contact strip. Furthermore, the sensor can also be attached directly to the contact strip and/or a contact strip holder of the contact strip. Additionally or alternatively, the sensor can be designed as a vibration sensor and be disposed on the fastening bearing of the contact strip. The contact strip can, for example, have two fastening bearings by means of which the contact strip is attached to the positioning device. In addition, a further contact strip can be disposed on the rocker element, which also has a sensor, so that this contact strip can also be monitored by the measuring unit. It is also possible that the sensor device comprises more than two sensors, which are disposed at the aforementioned points in order to be able to determine the characteristic value even more precisely.

Additionally or alternatively, recesses, such as drill holes, introduced into the contact strip, in particular into the contact element of the contact strip, can be detected by means of abrasion sensor technology. The abrasion sensor technology can have an acceleration sensor. Parallel to the direction of travel, at least three recesses can be introduced at a horizontal distance into the contact element of the contact strip, preferably so as to penetrate the contact element of the contact strip, at the level of a wear limit. These recess are exposed when the wear limit is reached and cause a characteristic vibration due to the contact with the catenary, taking into account the tensile speed. These vibrations can be detected with at least one acceleration sensor, for example. Preferably, the recess have a diameter of 2 mm to 5 mm. It is further preferred that the recesses have a diameter of 3 mm.

The positioning device can have a rocker element holding the contact strip and a base frame disposed on the rail vehicle and an articulated element disposed between the base frame and the rocker element. At least one sensor disposed on the rocker element and at least one power supply unit disposed on the articulated element and/or the base frame can be used as part of the method according to the invention. By disposing a sensor on the rocker element, measured values can be registered near the contact element and the catenary wire of the catenary, for example by means of an acceleration or vibration sensor. Preferably, a first electrical line of a DC power supply element is disposed on the articulated element and an AC power supply element is disposed on the base frame of the positioning device. The current yielded by a first and/or second power supply element, for example an AC power supply element and a DC power supply element, can be conducted to a base unit, preferably attached to the base frame, where it can be converted and/or further distributed.

As described above, the positioning device can have a rocker element holding the contact strip and a base frame disposed on the rail vehicle and an articulated element disposed between the base frame and the rocker element. The measured values of at least two sensors can be transmitted to a data-concentrator element disposed on the articulated element and/or the rocker element and configured for data concentration. Transmission takes place preferably in a wired manner. By using data-concentrator elements, a plurality of sensors of a measuring unit and/or several measuring units can be linked via a tree structure of the bus cabling. In the context of the present invention, it has been realized that cabling in a tree structure is advantageous compared to a linear structure, such as in a known linear CAN bus. In particular, the tree structure can be formed by means of simple and symmetrical cabling and has significantly increased flexibility compared to linear cabling. The amount of data can also be concentrated and/or reduced by using data concentrator elements, meaning only selected and/or already processed data needs to be transmitted. This significantly reduces the effort of data transfer. A data concentrator element can be provided on a rocker element and/or a contact strip and/or a contact element in order to form a tree structure of the cabling according to the invention. Preferably, two data concentrator elements can be provided for each rocker. Alternatively or additionally, a data-concentrator element can be provided on the articulated element, in particular in the area of the knee of the articulated element, i.e., in the area of the joint between the upper arm and the lower arm. This means that an initial data concentration can take place directly on the rocker element and a further data concentration can take place on the articulated element. It is conceivable that the data-concentrator element has an acceleration sensor, a gyroscope and/or a rotation sensor. For example, a knee data concentrator device provided on the knee of the articulated element can determine the height of the rocker element relative to the rail vehicle using at least a gyroscope and an acceleration sensor as well as the analytics of the measurement of the angle at the knee. In addition, the data-concentrator element disposed on the knee can register information on a lateral deflection of the articulated element and thus of the current collector. The data-concentrator element on the knee of the articulated element can also be used to activate a measuring unit. The data-concentrator element can thus determine whether the contact strip abuts against the catenary wire due to the distance between the rocker element and the rail vehicle and/or whether the train is moving. If the train is moving and/or the contact strip abuts against the catenary wire of the catenary, the measuring unit can be activated. Alternatively or additionally, activation can also take place by means of a pressure sensor disposed on a spring element of the positioning device or by means of a voltage sensor on an electric-motor-driven drive element of the positioning device.

According to a further embodiment, the voltage applied to an electric line of the current collector and/or the electric current can be measured in an electric line of the current collector by means of at least one sensor of a base unit of the measuring unit disposed on the base frame. The electrical line is preferably formed from a metal profile, a conductor rail and/or a bus bar through any of which the current required by the rail vehicle flows from the contact strip to the rail vehicle. The sensors disposed on the base unit can, for example, detect and/or compute vibrations and/or inclined positions of the train. The registration of measured values on the base unit disposed on the base frame can advantageously make the assignment of fault patterns and/or the detection of characteristic values more precise. The measured values determined by the base unit disposed on the base frame connected to the rail vehicle can allow conclusions to be drawn as to the extent to which faults or anomalies are attributable to the rail vehicle itself, the condition of the tracks on which the rail vehicle is traveling or actually to the current collector and/or the catenary wire.

The pressure of a pressure line of the positioning device can be measured by means of a pressure sensor disposed on the base frame. Preferably, the pressure of a pressure line of the positioning device is measured by means of at least one pressure sensor which is connected to the base unit of the measuring unit disposed on the base frame. Preferably, a pressure line of the positioning device is monitored by means of the pressure sensor in the case of air flow collectors, which are typically used in long-distance transportation (heavy rail and high-speed). The static pressing force and/or dynamic fluctuations can be determined from the pressure values measured at a pressure line in the positioning device. The pressure sensor and/or the measured values registered by the pressure sensor can also be used to put the measuring unit into standby mode and/or to reactivate the measuring unit in the event of movements and/or pressure changes indicating that the rail vehicle is moving. For example, an increase in pressure in the pressure line of the positioning device can draw conclusions about the rocker element being raised by means of the positioning device and therefore about the rail vehicle.

The processing element can perform an analysis of the measured values while the contact strip is guided along the catenary wire. Consequently, the processing element can perform this analysis while the rail vehicle is moving. Within the scope of the method, measured values may also be analyzed during a stop of the rail vehicle, for example at a station or a stop. In particular, characteristic values for an operating state of the catenary can preferably only be obtained when the contact strip is guided along the catenary wire.

The processing element can register and store the measured values of the sensors and/or the characteristic values in regular temporal intervals, upon change or continuously. Accordingly, it can be provided that the measured value and/or the characteristic value are only registered and stored when the values change in order to keep the amount of data low.

Alternatively, it is possible to provide continuous registration and storage. By storing the measured values and/or characteristic values, it is possible to carry out processing even after registration. For example, measured values can then be registered while the rail vehicle is moving, the characteristic value(s) can only be determined during maintenance of the rail vehicle in a depot. For example, the condition of a catenary along a route of the rail vehicle can be determined after a journey.

The measuring device can have a control device by means of which an actuator for actuating the positioning device can be controlled, the actuation of the positioning device being able to be regulated by means of a regulation element of the control device in accord with a measured value and/or a characteristic value. The drive element can comprise the actuator, which can be connected to a rocker element and/or rocker element of the positioning device in such a manner that a linear movement of the actuator can cause a movement of the contact strip between the sliding contact position and a storage position. The actuator can, for example, be formed by a linear drive or a pneumatically or hydraulically actuated cylinder or bellows. It is also possible that the pressing force is changed via the actuator or that the actuator forms the pressing force. The actuator then forms the spring element and/or is combined with it. The control device can now receive signals and/or measured values and/or characteristic values from the measuring device and use these by means of the regulating element to regulate the drive element. If, for example, the processing element detects a break in the contact strip, the actuator can be used to swivel the contact strip into a storage position on the rail vehicle. Moreover, it is also possible to regulate the pressing force via the actuator. In principle, such a control device can also be present as an assembly of the rail vehicle independently of the measuring device.

The pressing force can be regulated by the regulating element as a function of the measured values and/or the characteristic values. For example, the pressing force can be generated to be essentially constant, independent of an angular position and a movement of the positioning element. This can also largely prevent the contact strip from lifting off the catenary wire as a result of unevenness or other influences. The processing element can, for example, output a characteristic value to the control device after the contact strip is accelerated away from the catenary wire, the control device then being able to exert a counterforce via the regulating element and/or the actuator on, for example, a rocker element to prevent the contact strip from lifting off. At the same time, it is also possible to regulate the pressing force in such a manner that no excessive wear of the contact strip occurs as a result of increased pressing force. The pressing force can then also be comparatively reduced if an improved electrical contact can be formed with the catenary wire.

The measuring device can transmit the measured values and/or the characteristic values to an evaluation unit, the measured values and/or characteristic values being able to be stored in a databank of the evaluation unit and/or being able to be processed by means of an evaluation device of the evaluation unit. The evaluation unit can therefore comprise the database and the evaluation device. The evaluation unit can therefore serve to collect and further process the measured values and/or characteristic values and can be formed by a computer. The evaluation unit can be a computing device which is remote from the measuring unit and/or the rail vehicle and which enables, for example, a cloud service. The measured values and/or characteristic values can be transmitted automatically and/or at the request of the evaluation unit. For example, the evaluation device can display or output a result of an evaluation to an operator. The evaluation unit can have a range of functions which goes beyond the range of functions of the processing element. By combining the measured values and/or characteristic values of several measuring units, the evaluation unit can increase the quality of the statements pertaining to the condition of the monitored components of the current collector and can particularly clearly assign causes of damage to the catenary or current collector and their effects, for example certain characteristic values, since several characteristic values and/or several measured values, for example from several measuring units and/or measuring devices in the sense of swarm intelligence, can be combined and processed for each component of the current collector. By combining different sensor types, “virtual sensors” can also be generated. In the context of the invention, the swarm effect is to be understood as a combination of data from different sensors and/or different sensor elements and/or different measuring devices and/or different measuring units and/or different monitoring systems.

In principle, however, it is also possible to integrate the processing element in the evaluation unit and vice versa. Such an evaluation unit can also be present as a component group of the rail vehicle, independently of the current collector.

The measuring device can have a transmission element by means of which the measured values and/or characteristic values of the measuring device can be transferred to the evaluation unit and/or to the control device via a data connection, the evaluation unit and/or the control device being able to be spaced apart from the measuring unit or being integrated in the measuring unit. If the control device and/or the evaluation unit is integrated in the measuring unit, the data connection can simply be formed by a line connection. It is then also possible to install parts of the measuring device, such as the processing element and the control device as well as the evaluation unit, elsewhere on the rail vehicle. When transmitting the measured values and/or characteristic values, data can be exchanged, for example on the basis of a transmission protocol. The data connection can be established continuously, at regular intervals or event-based. Overall, this makes it possible to collect and evaluate data collected by the measuring device. A variety of possibilities for evaluation then make possible an analysis of certain states and events, which can be used to optimize the operation of the current collector and the catenary and/or the rail vehicle.

The data connection can be established via an external data network. In this context, the data connection can be established via a mobile phone network, WLAN, a satellite connection, the Internet or any other wireless standard, either on its own or in combination. If the evaluation unit and/or the control device is spaced apart from the measuring unit, it can also be disposed outside the rail vehicle, far away from the rail vehicle in a stationary manner, for example in a building. In particular, this makes it possible to monitor and/or control a function of the current collector on the rail vehicle without this task having to be carried out by a person on the rail vehicle itself.

The evaluation unit can process measured values and/or characteristic values of measuring units of several current collectors. In this manner, the evaluation unit can process measured values and/or characteristic values of several current collectors disposed on an individual rail vehicle. By comparing the measured values and/or characteristic values of the current collectors, the accuracy of a measurement and/or monitoring can be further increased. In addition, the evaluation unit can be used to process characteristic values of current collectors disposed on different rail vehicles. This can also significantly improve the accuracy of measurements and monitorings of the rail vehicles and/or the respective catenary. Among other things, an up-to-date and constantly changing status image can thus be obtained of a route network and the rail vehicles operating on it. The resulting optimization of an operating state can significantly reduce operating costs. Regular and frequent inspections of the infrastructure and rail vehicles are no longer necessary to their full extent and vehicle safety during operation is significantly increased. There is also no need to carry out special measurement runs.

A user unit can form a data connection to the evaluation unit and/or to the measuring unit, the measured values and/or the characteristic values being able to be transmitted and output to the user unit. The measured values and/or characteristic values as well as the results of the evaluations of the measured values and/or characteristic values can be made available to an end user via the user unit. The user unit can be a computer which is independent of the evaluation unit and/or the measuring unit. This computer can be a stationary computer, a mobile device or the like, with which a further data connection can be established for data exchange with the evaluation unit and/or the measuring unit. The data exchange can take place via an external data network, such as the Internet, for example. In this manner, data processed using the evaluation unit and/or measured values and/or characteristic values processed with the evaluation device can be made available to a wider range of users. The measured values and/or characteristic values or the results of the evaluations of the measured values and/or characteristic values can be made available individually to an end user via the user unit. The evaluation unit can, for example, be formed by a server with software which transmits the information contained in the database of the evaluation unit to the user unit. This transmission can consist of the provision of a website with selected information, such as the current wear status of the contact strip. Such a web page or web interface may be provided to make data visually accessible to the end user. The website or web interface can be tailored to the end user and their application cases. The evaluation unit, the measuring unit and/or the user unit can transmit data to various systems of the end user, e.g., to existing systems of an end user, such as a rail network operator. Alerts and/or warning messages and/or informational messages can also be sent and/or output via an evaluation unit and/or user unit.

The processing element or the evaluation unit can evaluate a temporal sequence of the measured values and/or the characteristic values and determines a wear state of the current collector and/or the catenary while taking into account a time-dependent component relevant for the wear and/or a component dependent on the measured variable. In this manner, not only can a statement be made pertaining to the current state of wear, but it is also possible to determine approximately when a contact strip or a catenary wire is likely to be worn out, for example. This makes it possible to precisely determine a maintenance interval for the current collector and/or the catenary and to optimize it in terms of time, for example by adapting it to the actual state of the current collector and/or the catenary. In addition, the temporal sequence can also be used to determine when certain events occurred. If events occur repeatedly, a system can be derived from this. For example, a poorer electrical contact or increased wear can be detected when a certain track section is used.

The sensor element can register a vibration of the contact strip, the processing element or the evaluation unit being able to determine a wear state of the contact strip and/or the catenary. If the contact strip is worn, a shape, in particular a height of the contact strip, can be changed, the change in shape also being able to change the vibration behavior of the contact strip. For example, the processing element can also determine a natural frequency and/or a resonance frequency of the contact strip and/or the positioning device as a vibration. The processing element can determine a degree of wear of the contact strip, the positioning device and/or the catenary from the vibration. If a vibration behavior changes with increasing abrasion of the material of the contact strip and/or a component of the positioning device or of the catenary wire, this change can be used to draw conclusions regarding the degree of wear of the contact strip, the positioning device and/or the catenary wire. For example, it is not only possible to determine whether the contact strip is new or completely worn, but also to what extent the contact strip is worn. The shape of the contact strip is essentially determined by the abrasion of the carbon material of the contact element on the contact strip. This can essentially result in a difference in the height of the contact strip and/or the contact element between a new and a worn contact strip. Since the contact strip is regularly contacted by and/or brushes the catenary wire along a length of the contact strip in a continuous alternation during a journey of a rail vehicle, wear of the contact strip, in relation to a length of the contact strip, can occur unevenly. This means that abrasion of the contact strip can be greater in the middle of the contact strip than at its edges. Grooves can also form on the contact strip depending on the condition of the catenary. A height of the contact strip can therefore change unevenly according to use, which influences the shape of the contact strip. Furthermore, the continuous regular change of the catenary wire along the length of the contact strip can be registered while a rail vehicle is moving, meaning the condition of the contact strip can also be determined from this.

The processing device can compute the shape using the finite element method. For example, it may be provided that the processing device computes a possible shape of the contact strip from the vibration behavior of the contact strip using a computation model based on the finite element method. In particular, the possible abrasion of the contact strip described above can be taken into account here. This makes it possible to determine the wear state of the contact strip even more precisely.

The processing element or the evaluation unit can determine a light arc on the contact strip and/or the catenary wire, a zigzagging catenary wire, an icing of the catenary wire and/or defects of the catenary wire as an operating state. In the context of the invention, the term “defects of the catenary wire” can also include incorrect laying and/or positioning of the catenary wire in addition to damage and/or defects of the catenary wire. The arc can be determined, for example, by measuring a current transmitted at the contact strip. Furthermore, an illuminance or luminance can be measured in the area of the catenary wire so that the presence of a light arc can be determined with a high degree of certainty from both measured values if measurement peaks occur at the same time. As the catenary wire is regularly disposed in a zigzagging pattern along a travel path, this zigzagging pattern of the catenary wire can also be determined, for example, by means of acceleration sensors and/or inductive sensors. This also makes it possible to create a profile of the catenary along the route. The profile of the catenary can be stored in the evaluation unit in the form of a map of the catenary and/or the course of the catenary wire. Any defects detected on the catenary and/or the catenary wire can then be precisely assigned to a clearly specifiable point on the catenary. Icing of the catenary wire can also be easily determined by a plurality of sensors and/or measured values, for example by measuring the outside temperature and the air humidity in the area of the catenary wire. Areas and/or track sections of the catenary along the route can also be identified where icing is more or less likely, for example in the area of bodies of water. This data can also be stored in the evaluation unit. In addition, defects in the catenary wire and/or the catenary can be detected using sensors, for example a shock applied to the contact strip as a result of a defect in the catenary wire using an acceleration sensor and a changing pressing force using a pressure sensor at the same time. Overall, this makes it possible to draw conclusions about an operating state of the catenary by combining several measured values from sensors of the same or different types, and to document this operating state in the form of characteristic values and/or other data suitable for describing the operating state. In particular, this does not require a dedicated measurement run, as the measured values can be recorded easily and repeatedly during regular operation.

The processing element or the evaluation unit can perform a sample analysis or statistical evaluation of the measured values stored over a period of time and/or characteristic values and derives a characteristic number from the sample analysis or the statistical evaluation. This makes it possible to use the sample analysis to determine a correlation between measured values, characteristic values and/or data records, provided a correlation exists. Causal relationships can regularly be derived from correlations. Correlations found by the sample analysis can be used in the simplest embodiment of the method to determine causal relationships, knowledge of which can in turn be used to optimize the operation of rail vehicles. For example, the occurrence of a fault in a track section of a catenary can correlate with a certain type of rail vehicle or a current collector. This makes it possible to determine the cause of the fault and/or the causal relationship between the rail vehicle and the fault and to rectify it in a targeted manner. If a sufficient amount of data is available, it can be examined using a statistical evaluation to ensure that it is not a case of randomly detected events, for example. Nevertheless, it is possible to use the statistical evaluation to compute a weighting, for example of a fault or a frequency, as well as a probability of occurrence of the fault.

The processing element or the evaluation unit can correlate the measured values of different sensors and/or characteristic values to each other and derives functional dependencies of the measured values and/or characteristic values by means of artificial intelligence. It may also be intended to perform the sample analysis using artificial intelligence. The artificial intelligence can be used, for example, in the context of machine learning or deep learning and/or classification of data. According to a preferred embodiment, statistical models can be created using machine learning (ML). The characteristic values determined can be used in machine learning as features or training data, patterns and/or regularities being able to be identified in the training data. Functional dependencies between the sensors can also be investigated. For example, a transmitted current can be correlated to a temperature and it may be possible to determine that a catenary wire is iced over. Furthermore, a sample analysis of the measured value and/or characteristic value can detect a section of a catenary wire which is thinner compared to an intact or new catenary wire and thus draw conclusions about potential sources of error and/or failure. A number of other operating states and events can also be identified and interpreted as a result of functional dependencies, for example changes along a catenary wire and their relative position, an incline and number, a lifting-off of the contact strip from the catenary wire and, if applicable, sparking and/or arcing, a wear of the contact strip as a result of mechanical friction on the catenary wire and/or an electrical burn-off as a result of a pressing force, in particular an averaged wear over a route, track section with particularly high or particularly low wear, a wear rate as a function of a driving behavior, such as acceleration or standstill current load, damage and/or position deviations of the catenary and/or the catenary wire, a current load, such as short-term overcurrent, short-circuit current, triggering of a protective fuse or a short-circuiter in the event of a fault, a state of wear components of the current collector, such as bearings, joints, structural elements, a breakage of the contact strip, for example as a result of an impact on an obstacle, a position, speed, acceleration and direction of travel of the rail vehicle. These exemplary conditions and events mentioned above can be accordingly responded to by maintenance measures, an adjustment of the driving behavior of the rail vehicle or other suitable measures.

In addition, the processing element or the evaluation unit can correlate signals and/or measured values from sensors not associated with the current collector and/or characteristic values with signals and/or measured values from the sensors associated with the current collector and/or characteristic values. For example, by additionally taking into account signals and/or measured values and/or characteristic values from sensors of an earthing contact, a wheel flange lubrication, a shaft earthing, etc. In principle, it is possible to use the processing element to process all signals determinable on the rail vehicle and/or measured values in this manner.

A position sensor of the sensor element can determine a local position of the current collector, the local position being able to be assigned to the characteristic values or the measured values of another sensor of the sensor element, the evaluation unit being able to determine a state of the catenary. The position sensor can, for example, use satellite navigation to determine a position of the current collector and thus of the vehicle. This makes it possible, for example, to determine at which point on a route a certain measured value of another sensor of the sensor element was registered. This allows assigning the relevant local position to an event and/or measured value. Furthermore, it is possible to use the evaluation unit to determine the state of the catenary, for example by evaluating vibrations of the current collector and/or a rocker element along the catenary. For example, the rocker element can exhibit altered vibration behavior if the catenary wire is heavily worn. Steps, interruptions and ramps on the catenary wire can also be determined and assigned to a position on the track. This can be used to influence the speed of the rail vehicle in the sections of the route localized in this way.

The evaluation unit can generate a data model of the catenary along at least a track section of a route of the rail vehicle, the data model being able to comprise a plurality of different local positions of the track section, which each have assigned measured values and/or characteristic values. The data model may be stored in the evaluation unit and may comprise data and/or files describing a course of the catenary. The data model may be a graphical representation and/or mapping of the course of the catenary along the route or, in a simpler embodiment, a list comprising, for example, components of the catenary. The data model may comprise the plurality of different local positions of the relevant track section and/or route as respective data sets, so that the structural properties of the catenary are represented by the data model. The local positions and/or data records can each be assigned measured values and/or characteristic values. For example, the data model can include information about a zigzagging course of the catenary wire with a length of the respective straight sections of the catenary wire. A local position and/or a route length of the route in relation to a reference point can be assigned to this zigzagging course. If measured values are now determined using sensors or characteristic values are now determined using the processing element, these can be assigned to a local position of the relevant track section if the local position is known or determined during the relevant measurement. In this manner, any events or defects in connection with the catenary can be documented and, if necessary, located precisely on site, for example for repair, by knowing the local position.

The data model can be adapted by continuously and repeatedly registering measured values and/or characteristic values for journeys of the rail vehicle along the track section. For example, a route can be repeatedly traveled with one or more of these current collectors on one or more different rail vehicles. If measured values and/or characteristic values are registered in each case, the data model stored in the evaluation unit can be improved by continuous comparison. For example, events which occur only once are recognized as such and can be disregarded, whereas recurring events indicate a special characteristic or a problem with the catenary or the current collector and/or the rail vehicle at a specific local position. The continuous adaptation of the data model can document usage intensity and the associated wear, which enables improved planning of maintenance measures and servicing. The continuous adaptation of the data model can also be used to determine the local position in such a manner that the local position of a current collector is determined by the data obtained from the current collector during a journey and its comparison with the data model.

Furthermore, a measuring unit can be used which is formed on the current collector independently of the rail. The measuring unit can then be disposed and/or integrated on the current collector independently of the rail vehicle in terms of location and/or function. A connection between the measuring unit and the rail vehicle is therefore not absolutely necessary. In particular, the measuring unit does not need to be connected to a low-voltage network of the rail vehicle. The measuring unit and thus the current collector can thus be used independently of the type of rail vehicle and without special certification from a rail vehicle manufacturer. Nevertheless, it can optionally be provided that the measuring unit is connected to the rail vehicle, for example to a driver's cab of the rail vehicle, in order to signal measured values and/or characteristic values to a vehicle driver. In particular, a bidirectional data exchange can take place between the measuring unit and the rail vehicle. For example, wear can be signaled in a driver's cab or measured values of the rail vehicle available in the driver's cab, such as speed, can be processed by the measuring unit. Preferably, however, the measuring unit can be used independently of the rail vehicle.

The characteristic value can be determined during operation of the rail vehicle when the current collector abuts against the catenary wire, the characteristic value being able to be determined alternatively or additionally during a stationary operation of the rail vehicle, the current collector being able to be positioned in a rest position or being able to be moved between a contact position against the catenary wire and the rest position on the rail vehicle. The characteristic value can then only be determined on the basis of the measured value which can be registered in the rest position. When the contact strip is released from the catenary wire or when the contact strip is moved from the rest position on the rail vehicle in the direction of the catenary wire, vibrations are induced in the contact strip, the contact strip then being able to vibrate essentially unaffected by external influences. This makes it possible, for example, to use the vibration of the contact strip to determine the state of wear.

The current collector is disposed on a roof of a rail vehicle and is configured for transmitting power from a catenary wire of a catenary to the rail vehicle, the current collector comprising a positioning device having a contact strip disposed thereon, the positioning device being designed such that the positioning device moves the contact strip relative to the catenary wire and presses it against the catenary wire to a sliding contact position using a pressing force in order to form a sliding contact, the positioning device having a drive element and/or a spring element by means of which the pressing force to the contact strip is generated. According to the invention, the current collector has a power supply unit disposed on the current collector and a measuring unit having a measuring device, at least two sensors of a sensor element of the measuring device being disposed on the positioning device and/or the contact strip, and the power supply unit yielding at least the electric energy required for supplying power to the sensors of the sensor element, and a processing element of the measuring device processing the measured values, the sensors each registering measured values in the sliding contact position, the processing element correlating the measured values to each other and determining a characteristic value describing an operating state of the current collector and/or the catenary. Regarding the embodiments and advantages of the current collector, reference is made to the description of the method above.

It is understood that the explanations given with regard to the method relate in an equivalent manner to the current collector according to the invention and to the monitoring system according to the invention without being mentioned separately for the latter.

According to a preferred embodiment, the positioning device of the current collector can have has a rocker element holding the contact strip and a base frame disposed on the rail vehicle and an articulated element disposed between the base frame and the rocker element. With reference to the description of the method above, at least one sensor can be disposed on the rocker element and at least one power supply unit on the articulated element and/or the base frame. Preferably, a first and a second power supply element are disposed on the articulated element and/or on the base frame, a first power supply element yielding energy when the current collector is operated in an alternating current network and a second power supply element being designed to yield energy when the current collector is operated in a direct current network.

A data concentrator element can be disposed on the articulated element and/or the rocker element of the positioning device. Data and/or measured values can be processed and/or bundled in the data concentrator element in order to reduce the amount of data to be forwarded. A data-concentrator element can be connected to at least two sensors and/or measuring devices. In addition, a data-concentrator element can be connected to a plurality of other data-concentrator elements, which means that the data volume of several upstream data-concentrator elements can be further reduced by means of a data-concentrator element. Data concentration and data-concentrator elements can be used to create a tree-like structure of the connection between the components of a measuring unit and/or a monitoring system. Preferably, the data transmission between measuring units, sensors and data-concentrator elements is cable-bound, so that a tree-like cabling structure is also created. At least one data concentrator element can be connected to a base unit. According to a particularly preferred embodiment, four sensors can be disposed on the rocker element, preferably two sensors being assigned to a contact strip, two sensors being assigned to a data concentrator element each. In other words, this means that two data-concentrator elements are disposed on the rocker element, each of which is connected to two sensors and reduces their data volumes. A further data-concentrator element can be disposed at the knee of the articulated element. This data-concentrator element disposed at the knee of the articulated element is connected by cable to the base unit, the data and/or measured values arriving in the base unit being further processed, reduced and/or forwarded in the base unit. The forwarding of data from the base unit is preferably carried out wirelessly.

It is conceivable that the base unit of the measuring unit has a pressure sensor, a current sensor and/or a voltage sensor. Thus, in addition to processing the data received from other sensors and forwarding it, the base unit can also register data relating to pressure, voltage and current. It is also conceivable that a pressure sensor, a current sensor and/or a voltage sensor are disposed on the base frame and/or the positioning device and that their measured values are transmitted to the base unit for evaluation and/or forwarding.

A monitoring system can comprise a plurality of rail vehicles which each have at least one current collector, the monitoring system comprising an evaluation unit for processing measured values and/or characteristic values of the measuring units of several current collectors. As described above, this makes it possible to monitor several current collectors of a rail vehicle or several rail vehicles having current collectors and/or to control the relevant current collectors using one evaluation unit. Regardless, it can also be intended for each current collector to have an evaluation unit. The rail vehicles can also each have a plurality of current collectors. Overall, this makes it possible for the monitoring system to collect and evaluate data sets from the current collectors, regardless of the type of data connection. The monitoring system can also have an evaluation unit which is spaced apart from the current collectors and/or the rail vehicles and can be disposed in a stationary position far away from a rail vehicle, for example in a building. The data stored in the evaluation unit can then be used, for example, to establish correlations between a local position, a time of detection and any faults detected in the current collector; for example, a comparatively increased level of wear or a specific fault in the current collector or catenary can then be assigned to a time of year or a route.

The monitoring system can comprise one or a plurality of user units which are spatially separated from each other. The data connection(s) to the respective user units can be established via an external data network. The user unit can be a computer which is independent of the monitoring system. This computer can be a stationary computer, a mobile device or the like, with which the data connection for data exchange with the monitoring system can be established. Data can be exchanged via an external data network, such as the Internet, for example. In this manner, data processed by the evaluation unit can be made available to an extended user group via an output device. The output device can, for example, be a server having a software application which transmits the results computed by the evaluation unit and the information contained in the database to the respective user unit. This transmission can be achieved by providing a website with selected information, for example a current overview of a stock of current collectors, catenary lines and rail vehicles. The information can be made available to rail vehicle operating companies on an individual basis.

Further advantageous embodiments of a monitoring system are derived from the description of features of the method.

In the following, the invention is described in more detail with reference to the enclosed drawings.

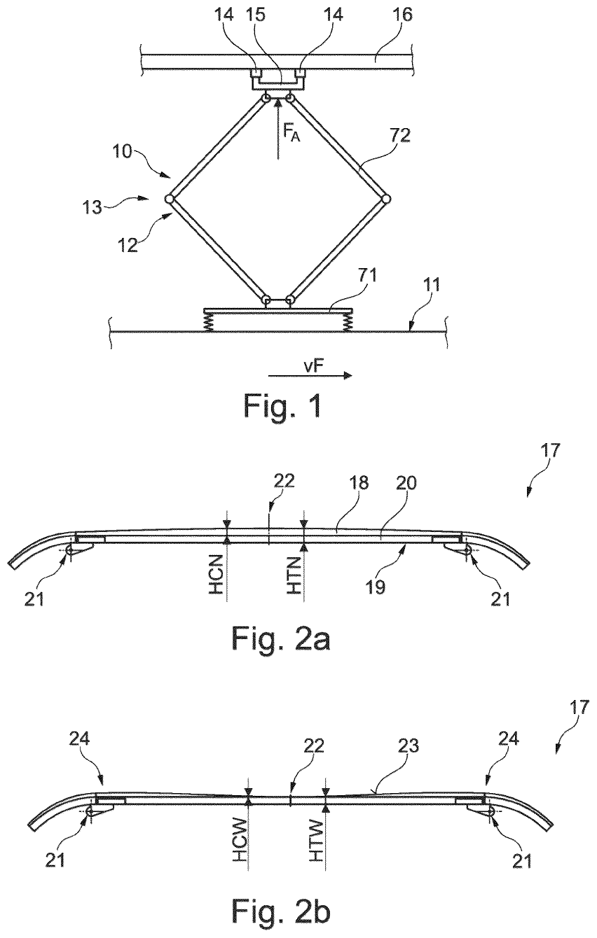

FIG. 1 shows a lateral view of a current collector on a rail ve-hi-cle.

FIG. 2a shows a front view of an unused contact strip.

FIG. 2b shows a front view of a worn contact strip.

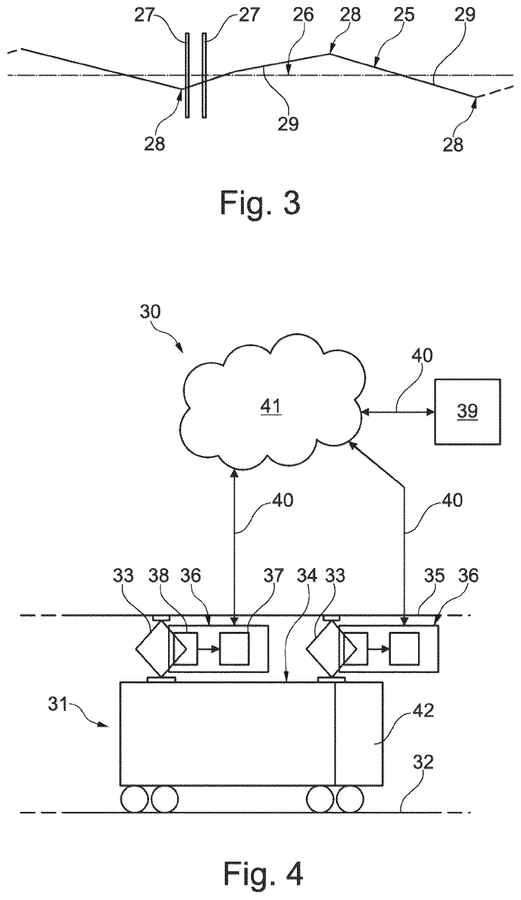

FIG. 3 shows a schematic view of a sectional of a course of a catenary wire.

FIG. 4 shows a schematic view of a monitoring system having a rail vehicle.

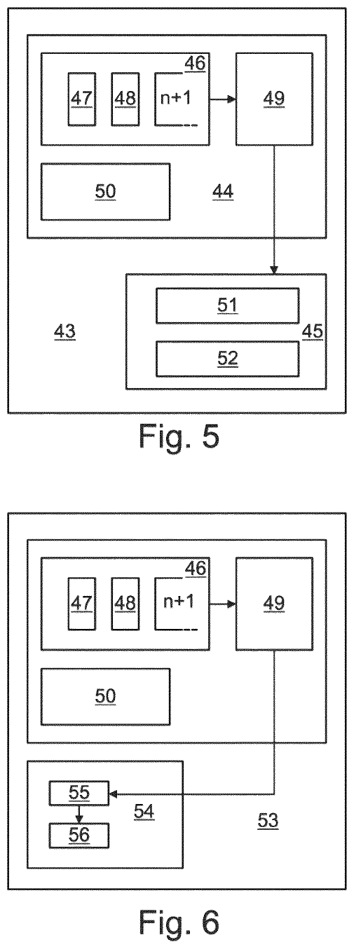

FIG. 5 shows a schematic view of a first embodiment of a measuring unit.

FIG. 6 shows a schematic view of a second embodiment of a measuring unit.

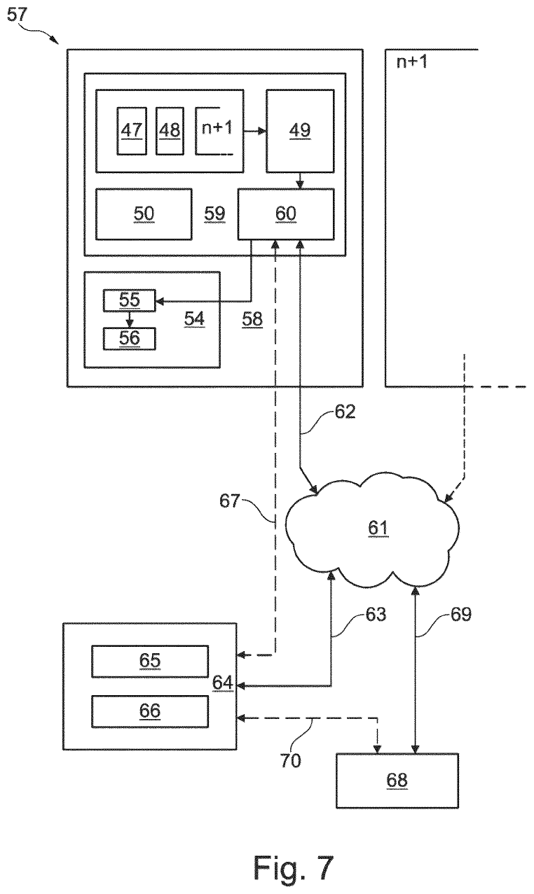

FIG. 7 shows a schematic view of another monitoring system.

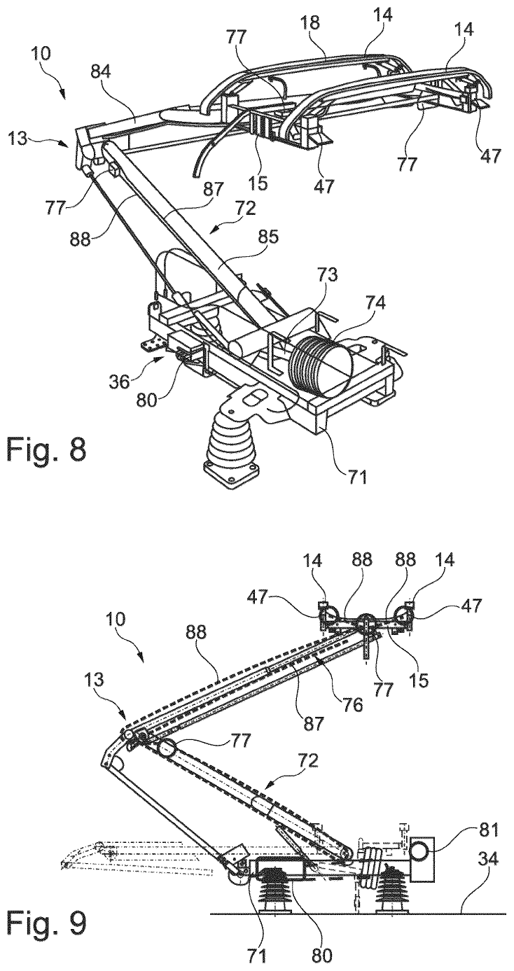

FIG. 8 shows a perspective view of a current collector.

FIG. 9 shows a lateral view of the current collector according to FIG. 8.

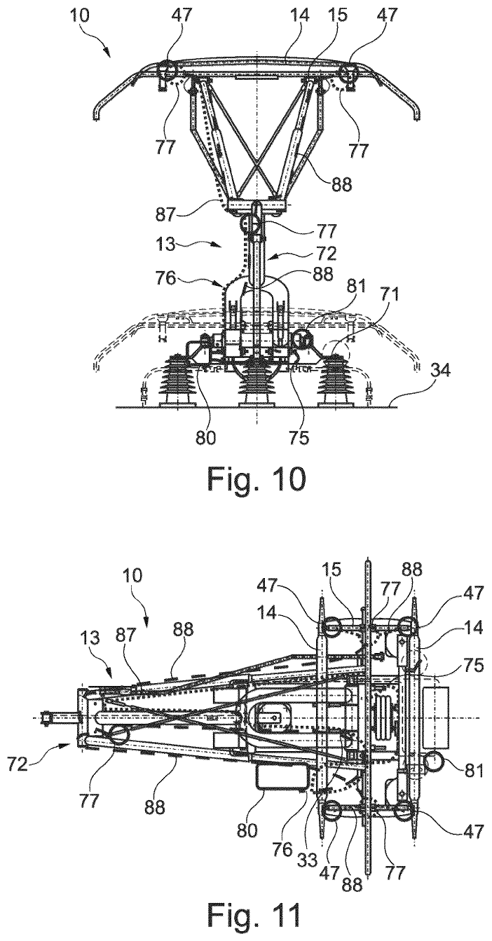

FIG. 10 shows a front view of the current collector according to FIG. 8.

FIG. 11 shows a top view of the current collector according to FIG. 8.

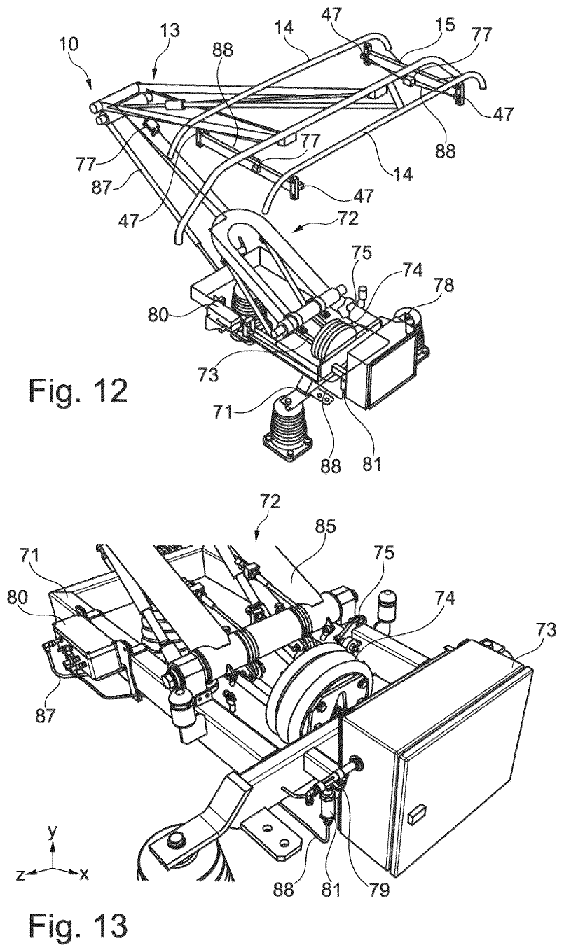

FIG. 12 shows another perspective view of the current collector according to FIG. 8.

FIG. 13 shows the base frame of the current collector according to FIG. 8;

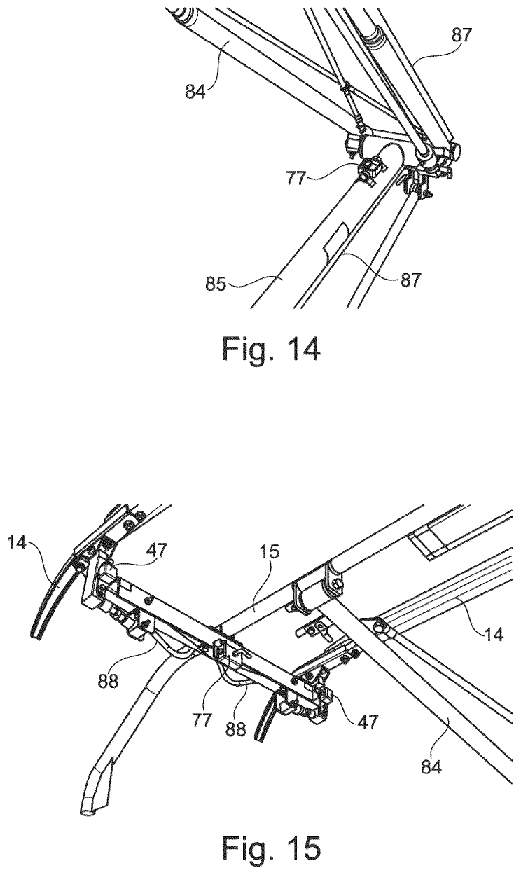

FIG. 14 shows a section of the articulated element of the current collector according to FIG. 8.

FIG. 15 shows a perspective view from below of a section of rocker element of the current collector according to FIG. 8.

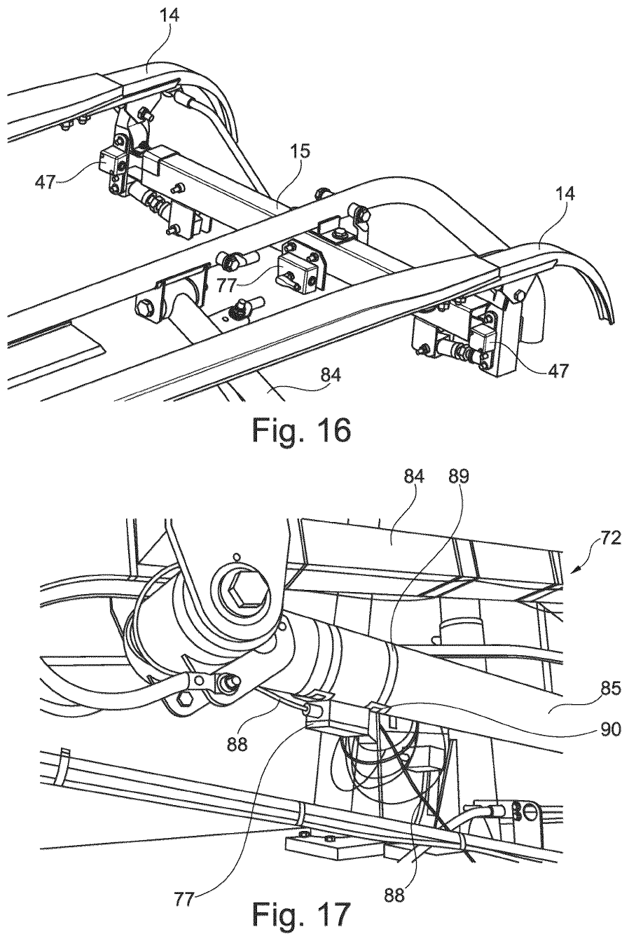

FIG. 16 shows a perspective view from above of a section of the rocker element of the current collector according to FIG. 8.

FIG. 17 shows a perspective view of a data-collector element disposed on the articulated element of the current collector according to FIG. 8.

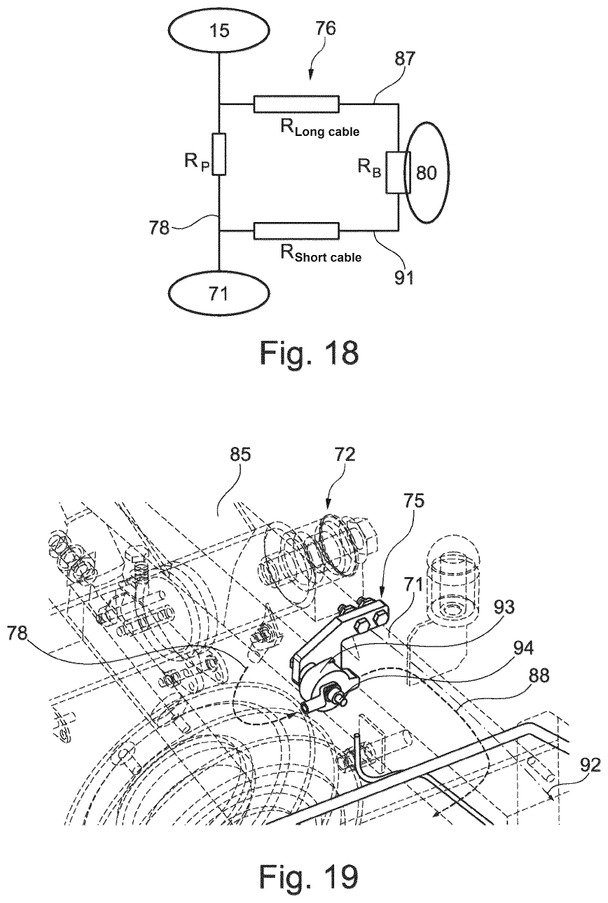

FIG. 18 shows a schematic view of a DC power supply element.

FIG. 19 shows a perspective view of an AC power supply element disposed on the base frame of the current collector according to FIG. 8.

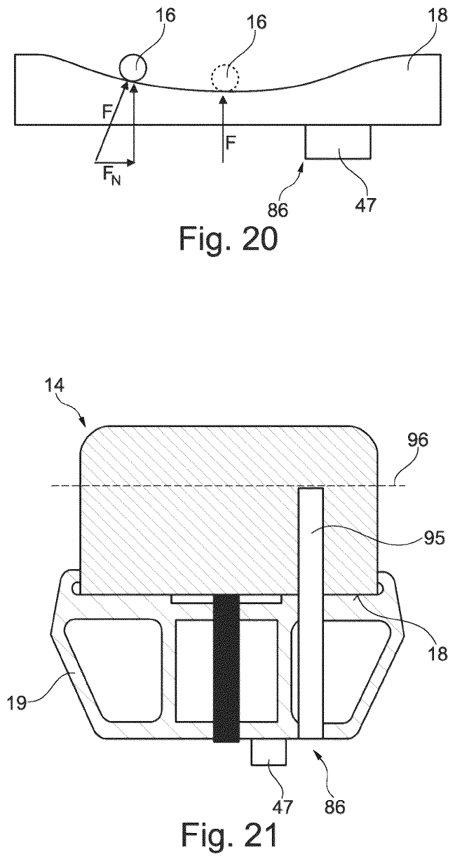

FIG. 20 shows a schematic view of a first embodiment of wear sensor technology.

FIG. 21 shows a cross section through a contact strip having a second embodiment of wear sensor technology.

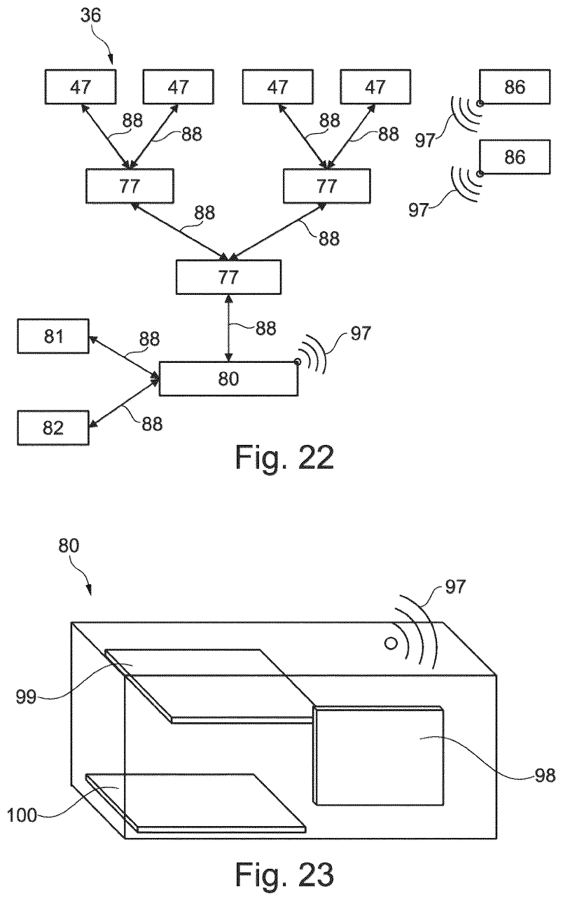

FIG. 22 shows a schematic view of a tree structure of a measuring unit.

FIG. 23 shows a perspective view of the base unit of a measuring unit.

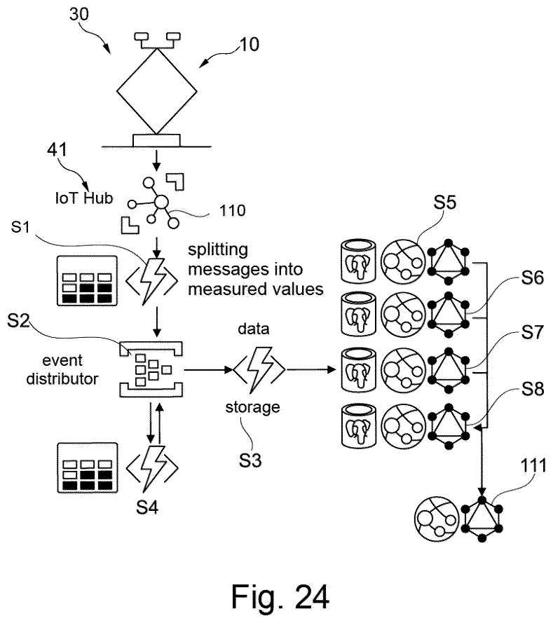

FIG. 24 shows a schematic view of the applications of an external data network.

FIG. 1 shows a current collector 10 on a roof 11 of a rail vehicle (not shown in detail here) having a positioning device 13 in the form of a pantograph 12. Two contact strips 14 are disposed on a rocker element transverse to a catenary wire 16 on the pantograph 12. The rocker element 15 is disposed on the articulated element 72. The base frame 71 connects the positioning device 13 to the roof 11 of the rail vehicle. The rail vehicle moves at a speed VF relative to the catenary wire 16, the contact strip 14 being pressed against the catenary wire 16 with a pressing force FA transverse and/or orthogonal to the catenary wire 16. The contact strip 14 is made of a carbon contact element (not shown in detail here) and a contact strip holder, the movement of the contact strip 14 on the catenary wire 16 as described here resulting in abrasion of the carbon material.

A synopsis of FIGS. 2a to 2b shows a contact strip 17 in various views and states of wear. The contact strip 17 essentially consists of a contact element 18, which is made of carbon or graphite, and a contact strip holder 19. The contact strip holder 19 has a profile 20, which is regularly made of aluminum, to which the contact element 18 is attached. Fastening bearings 21 are formed on the profile 20 and serve to connect the contact strip 17 to a positioning device (not shown here).

FIG. 2a shows the contact strip 17 in a new, i.e., unused, state, so that a height HCN of the contact element 18 and/or HTN of the contact strip 17 in the area of a center 22 of the contact strip 17 is unchanged and/or has a maximum value. In the area of the fastening bearing 21 and the center 22, acceleration sensors (not shown here) of a sensor device of a measuring system are attached.

FIG. 2b shows the contact strip 17 in a worn state, so that a height HCW of the contact element 18 and/or a height HTW of the contact strip 17 in the area of the center 22 is significantly reduced due to abrasion of a surface 23 of the contact element 18. This results in a changed vibration behavior of the contact strip 17, since a moment of resistance and/or a mass of the contact strip 17 is changed and/or reduced. Abrasion of the contact element 18 is most severe in the area of the center 22, since a catenary wire (not shown here) is formed in a zigzagging course and brushes the contact strip 17 on the surface 23 alternately between outer ends 24 of the contact element 18 and/or the surface 23 while the rail vehicle is moving.

FIG. 3 shows a schematic view of a catenary wire 25 relative to a route 26 and contact strips 27 of a current collector (not shown) of a rail vehicle. The catenary wire 25 shown here in sections forms a zigzagging course relative to the route 26. A catenary (not shown in detail here) is designed such that the catenary wire is held at attachment points 28 of the catenary. The catenary wire 26 extends in essentially straight sections 29 between the fastening points 28. When the rail vehicle travels along the route 26, the catenary wire 25 alternately brushes the contact strips 27 along their length. The current collector is equipped here with a measuring unit having a measuring device and with at least two sensors of a sensor element of the measuring device. The sensors can register vibrations of the contact strips 27 and a processing element of the measuring device can process these measured values and correlate them to each other. The processing element can use this to determine and/or compute an operating state of the catenary and/or a zigzagging course of the catenary wire 25.

FIG. 4 shows a schematic view of a monitoring system 30 together with a rail vehicle 31. The rail vehicle runs on a track 32 and has current collectors 33 on a roof 34 of the rail vehicle 31, which can be contacted with a catenary wire 35. The monitoring system 30 comprises a plurality of measuring units 36 on the current collectors 33, each having a processing element 37 and a measuring device 38. The monitoring system further comprises an evaluation unit 39, which receives, stores and processes data sets from the measuring units 36. The evaluation unit 39 can analyze the data sets and output a result of the analysis. The measuring units 36 are connected to the evaluation unit 39 via data connections 40, by means of which data sets are transmitted via radio signals, via an external data network 41. The data records can also be transmitted bidirectionally. The processing elements 37 register measured values of the measuring unit 36 and/or sensors (not shown here in detail) at the current collector 33, correlate them to each other and determine an operating state of the current collector 33 and/or the catenary wire 35 as a result. This result is transmitted to the evaluation unit 39 as described above. In principle, it is possible and sufficient to connect the measuring unit 36 to the external data network 41 via a single data connection. Optionally, it is also possible to exchange data sets between the measuring units 36 and the evaluation unit 39 by bypassing the external data network 41 and/or directly. The measuring units 36 can also be connected to a driver's cab 42 of the rail vehicle 31 in such a manner that the results and/or measured values of the processing element 37 can be displayed to a driver in the driver's cab 42.

FIG. 5 is a schematic view of a first embodiment of a measuring unit 43. The measuring unit 43 is formed from a measuring device 44 and further comprises an evaluation unit 45. The measuring device 44 in turn comprises a sensor element 46 having a plurality of sensors 47, 48 and a processing element 49. In addition, a supply device 50 is provided by means of which the measuring device 44 is supplied with electrical energy. The supply element 50 can be an energy storage device, a generator or an external power supply, for example via a rail vehicle or a catenary wire. The evaluation unit 45 has a database 51 and an evaluation device 52 and receives data and/or measured values and/or characteristic values from the processing element 49. The processing element 49 receives measured values from the sensors 47, 48 of the sensor element 46 and processes them. The measured values relate to operating parameters and/or physical measured variables of a contact pressure device of a current collector (not shown here) in the manner of the current collector shown as an example in FIG. 1. The processing element 49 processes the measured values in such a manner that it correlates them and a characteristic value describing an operating state of the relevant current collector and/or a catenary is determined. The characteristic values determined in each case are transmitted continuously or successively from the processing element 49 to the evaluation unit 45, where they are stored in the database 51 and/or are further processed and/or prepared by the evaluation device 52.

FIG. 6 shows a further measuring unit 53 in which, in contrast to the measuring unit of FIG. 5, the processing element 49 transmits data to a control device 54. The control device 54 is formed from a regulating element 55 and a positioning device 56, the regulating element 55 regulating an actuator (not shown here in detail) of the positioning device 56 depending on the transmitted data. Thus, the regulating element 55 regulates a pressing force of a contact strip of a current collector, which comprises the positioning device 56, in such a manner that lifting of the contact strip from a conductor rail is essentially prevented.

FIG. 7 shows a monitoring system 57 having a measuring unit 58. The monitoring system 57 can have a plurality of measuring units 58. In contrast to the measuring unit of FIG. 6, the measuring unit 58 has a measuring device 59 which comprises a transmission element 60. The transmission element 60 receives data and/or measured values and/or characteristic values from the processing element 49 and transmits these to the control device 54. Furthermore, there is a data connection 62 between the transmission element 60 and an external data network 61, the data connection 62 transmitting measured values and/or characteristic values via radio signals. An evaluation unit 64 having a database 65 and an evaluation device 66 is connected to the external data network 61 via a further data connection 63 and exchanges data and/or measured values and/or characteristic values with the transmission element 60 via the external data network 61. In principle, it is also possible to exchange this data directly via a direct data connection 62 by bypassing the external data network 61. In addition, a user unit 68 is provided, which is connected to the external data network 61 via a further data connection 69. The user unit 69 can thus exchange data with the evaluation unit 64, i.e., data from the measuring units 58 processed by the evaluation unit 64 can be output and/or displayed via the user unit 68 and made available for further use. The user unit 68 can also be directly connected to the evaluation unit 64 via a direct data connection 70. Overall, it is thus possible to yield measured values via sensors 47, 48 (not shown) attached to current collectors and to use these for direct control and/or regulation of the respective current collector by means of the control device 54. Furthermore, this data can be transferred via the external data network 61, for example the Internet, to the evaluation unit 64 for storage and evaluation. Functional correlations of the data can thus be used, evaluated and interpreted. The results of these evaluations can be made available to an end user via the user unit 68.

FIG. 8 shows a current collector 10, which essentially consists of a base frame 71 of a positioning device 13 and a rocker element 15 holding the contact strips 14. The positioning device 13 comprises an articulated element 72, which has an upper arm 84 and a lower arm 85, which are hinged together. The lower arm 85 is articulated on a base frame 71 of the current collector 10, while the upper arm 84 is connected to the rocker element 15. Furthermore, the current collector 10 has a drive element 73 disposed on the base frame and spring element 74. The current tapped by the contact strips 14 from the catenary wire is conducted via an electrical line 78 which is designed as a bus bar and is routed to the rail vehicle (not shown here) to be supplied with power via the rocker element 15, the upper arm 84, the lower arm 85 and the base support 71. The current dissipating through the bus bar 78 and/or the applied voltage is used by a power supply unit 50 to supply power to the sensors 47 disposed on the current collector 10. The power supply unit 50 can comprise a first power supply element 75 and a second power supply element 76. The first power supply element 75 is designed to yield the electrical energy required at least to supply power to the sensors 47 of the sensor element 46 from an alternating current. The second power supply element 76 yields the electrical energy required to supply power to the sensors 47 of the sensor element 46 by means of a direct current applied to the current collector 10. The first power supply element 75 is explained in more detail in FIG. 19, while the second power supply element 76 is explained in more detail in FIG. 18. FIG. 8 also shows the base unit 80, which, according to the present exemplary embodiment, has at least one connection for a data line 88 coming from the lower arm 85 of the positioning device 13, a connection for the power supply unit 50 and a connection for a data line 88 coming from a pressure sensor 81. The pressure sensor 81 is disposed on a pressure line 79 of the positioning device 13, which makes it possible to draw conclusions regarding the operation of the positioning device 13 and/or the height of the contact strips 14 connected to the positioning device 13 in the event of pressure changes in the pressure line 79 registered by the pressure sensor 81. The second power supply element 76 comprises a bypass line 87 connected to the base unit 80.

FIGS. 9 to 17 show in summary, in particular also in summary with FIG. 8, the structure of a current collector 10 according to the invention. It can be seen in particular from FIGS. 9 to 13 that a base unit 80 is disposed on the base frame 71 of the current collector 10, via which the current collector 10 is connected to the roof 34 of a rail vehicle. The data line 88 and the bypass line 87 of the second power supply element 76 run along the articulated element 72 via the base frame 71 to the base unit 80. In order to reduce the data transfer to the base unit 80, three data-concentrator elements 77, which are designed for data concentration, are disposed on the current collector 10. Specifically, one data concentrator element 77 is disposed in the area of the joint between the upper arm 84 and the lower arm 85 of the articulated element 72. Two further data-concentrator elements 77 are disposed on the rocker element 15. The data of at least two sensors 47, which are connected to a data concentrator element 77 via a data line 88, can be concentrated in the data concentrator elements 77, which are disposed on the rocker element 15. The sensors 47 are designed as motion sensors, with two sensors 47 being disposed on a contact strip each. The sensors 47, which are designed as motion sensors, can measure at least accelerations and rotations in three axes. In addition to data concentration, the data concentrator element 77 can also be used for registering measured values. For example, the data-concentrator element 77 can have a motion sensor which measures accelerations and rotations in three axes. Moreover, the base unit 80 can also have a motion sensor which measures accelerations and rotations in three axes. A total of at least eight motion sensors can thus be disposed on the current collector 10, these motion sensors being connected in a tree structure via data lines 88. This is described again in FIG. 22. The base unit 80 can comprise the processing element 37, in which the measured values of the measuring unit 36 and/or the sensors 47 and the data concentrator element 77 are set to function in relation to one another and an operating state of the current collector 10 and/or a catenary wire 25 (not shown here) is determined. The measuring unit 36 may further comprise a pressure sensor 81, which is disposed on the base frame 71. The pressure sensor 81 measures the pressure in a pressure line 79 of a drive element 73 or spring element 74 of the current collector 10. The data of the pressure sensor 81 is supplied to the base unit 80 via a data line 88. The base unit 80 can forward the measured values or the characteristic values determined by the processing element 37 to an external data network 41 (not shown here) or to an evaluation unit 39. The power supply of the monitoring system, in particular the power supply of the sensors 47 and data concentrator elements 77 comprised by the measuring unit 36, can be provided via the first power supply element 75 or the second power supply element 76, depending on the operation of the current collector 10. The first power supply element 75 is designed as an alternating current power supply element and is used when the current collector 10 is operated in an alternating current network. The first power supply element 75 is disposed on the base frame 71 and comprises at least one toroidal coil 93 and a bolt 94. The first power supply element 75 is described in more detail with reference to FIG. 19. The second power supply element 76, which is designed as a direct current power supply element, is used to operate the current collector 10 in a direct current network. The second power supply element 76 comprises a by pass line 87 extending from the rocker element 15 to the base unit 80. With reference to FIG. 18, the second power supply element 76 is described again.

FIG. 17 can be used as an example to describe the attachment of a data concentrator element 77 to the positioning device 13. According to the embodiment shown in FIG. 17, the data concentrator element 77 is disposed on the lower arm 85, in the area of the articulated connection with the upper arm 84 of the articulated element 72. The plate-shaped mounting device 90, via which the data concentrator element 77 is connected to the lower arm 85 by means of clamps 89. It can also be seen from FIG. 17 that a data line 88 coming from the rocker element 15 and routed via the upper arm 84 ends in the data concentrator element 77 and a further data line extends from the data concentrator element 77 in the direction of the base frame 71 (not shown here) and the base unit 80.

FIG. 18 schematically shows the mode of operation of the second power supply element 76, which is disposed on the positioning device 13, as can be seen in particular from a combined view with FIGS. 8 to 13. It is known that in order to supply power to a rail vehicle (not shown here) by transmitting power from the catenary wire to the rail vehicle, an electrical line 78, in this case in the form of a bus bar, leads from the rocker element 15 to the base frame 71 and from there on to the rail vehicle.

This electrical line 78 has a relatively low resistance, preferably in the milliohm range, and during operation a voltage of several 100 millivolts can drop across this electrical line 78 on the basis of this resistance, depending on the electric current of the current flowing through the electrical line 78. This voltage can be tapped by the second power supply element 76 and used to supply power to the monitoring system 30, in particular the measuring unit 36. For this purpose, the second power supply element 76 comprises a bypass line 87, which is preferably designed as a cable having a cross-section of 16 mm² . According to the invention, the bypass line 87 is laid along the articulated element 72 from the rocker element 15 to the base unit 80. A further contacting line 91, which is designed in the form of a cable and is preferably shorter than the bypass line 87, is used to make electrical contact between the base unit and the base frame 71. This results in a parallel circuit having a relatively high-impedance resistance compared to the electrical line 78 designed in the form of a bus bar, whereby a voltage sufficient to supply power to the measuring unit 36 can be tapped.

FIG. 19 shows, in conjunction with FIGS. 8 to 13, the mode of operation of the first power supply device 75, which is used when the current collector 10 is operated in an alternating current network. The toroidal coil 93 and the bolt 94 of the first power supply element 75 are attached to the base frame 71 by means of a holding device. The attachment is made at the point on the base frame at which the current is transferred from the lower arm 85 of the articulated element 72 to the base frame 71 by means of the electrical line 78, which is designed in the form of a bus bar. The toroidal coil 93 is pushed over the bolt 94 and the electrical line 78 is connected to the bolt 94 by means of a cable lug. Thus, when the current collector 10 is operated in an alternating current network, an alternating current flows through the bolt 94, which in turn induces an alternating current in the toroidal coil 93, which is conducted to the base unit 80 via a further electrical line and is converted into a usable direct voltage there. The current is discharged through the base frame via a current discharge 92. The bolt 94 is designed in such a manner that the bolt 94 does not restrict the current flow from the catenary wire to the rail vehicle via the electrical line 78. If the current collector 10 has several electrical lines 78 designed as a bus bar, each of the electrical lines 78 can be used for power supply by means of a first power supply element 75 and/or power supply element 76. Thus, a plurality of power supply elements 75 and/or power supply elements 76 can be provided on the current collector 10. Furthermore, as shown in FIG. 19, a data cable 88 for transmitting measured values to the base unit 80 can be provided on the first power supply element 75.

To determine the wear condition of a contact element 18 of a contact strip 14, the measuring unit can have abrasion sensor technology 86. The abrasion sensor technology 86 can be designed as shown in FIG. 20 or FIG. 21. According to the embodiment of the abrasion sensor technology 86 shown in FIG. 20, the forces F and FN acting between catenary wire 16 and contact element 18 are taken into account, which vary depending on the position of the catenary wire 16 and the state of wear of the contact element 18. It has been recognized in the context of the invention that, depending on the position of the catenary wire 16 and the wear of the contact element 18, characteristic vibrations or accelerations are caused at the contact element 18, which can be registered by means of a sensor 47, which is preferably designed as an acceleration sensor. These characteristic vibrations and/or accelerations can be used to determine the state of wear of the contact element 18.

Alternatively and/or additionally, the abrasion sensor technology 86 according to FIG. 21 can be used to determine the state of the contact element 18 of a contact strip 14. For this purpose, a recess 95 is formed in the contact element 18, the upper edge of the recess 95 defining the wear limit 96. As soon as the contact element 18 has worn down to the wear limit 96, the recess 95 is exposed and causes characteristic vibrations and/or accelerations that can be registered by the sensors 47. These characteristic vibrations and/or accelerations can be used to determine a characteristic value describing the state of wear and to indicate when the wear limit 96 has been reached.

FIG. 22 schematically shows the tree structure of the cabling of the measuring unit 36 on a current collector 10. As can also be seen from the combined view with FIGS. 8 to 16, two sensors 47 are disposed on each of the two contact strips 14 according to the exemplary embodiment shown in FIG. 22. Preferably, the sensors 47 are designed as motion sensors which can detect accelerations and vibrations in three axes. Two of the sensors 47 are connected to a data-concentrator element 77 each. The data-concentrator elements 77 can also have motion sensors. The two data-concentrator elements 77 connected to the sensors 47 are connected to a further data-concentrator element 77 via a data line 88 for further data concentration. This further data-concentrator element 77 transmits the data to the base unit 80 via a further data line 88. The base unit 80 can have a processing element 37 and/or transmit the data to an evaluation unit 39 or an external data network 41 via a wireless connection 97. Furthermore, the base unit is set up to receive and further process data received via a data line 88 from a pressure sensor 81 and/or electrical measurement sensor technology 82. The electrical measurement sensor technology 82 can comprise a voltage sensor and/or a current sensor, with which the voltage of the current collector applied to the electrical line 78 and/or the electrical current of the current flowing through the electrical line 78 can be measured. Furthermore, the base unit 80 is designed to wirelessly receive and further process data from abrasion sensor technology 86.

FIG. 23 shows a schematic structure of a base unit 80. The base unit has a logic board 99, a power supply board 100 and a circuit board 98 of the power supply unit 50. To form a wireless connection 97, the base unit 80 also comprises a wireless module.

FIG. 24 shows an example of data processing in an external data network 41, which according to FIG. 24 is designed as a cloud service application, in particular as an Internet-of-things hub 110. The measured values registered at the current collector 10 by the monitoring system 30 and/or characteristic values are transmitted wirelessly to the external data network 41. In the external data network 41, which is designed as a cloud service application, messages can be split into measured values and/or measured values and messages can be linked in a step S1. In a step S2, the data can be further distributed. Thus, in a step S4, copies of a measured value and/or characteristic value can be created for each user. In addition, the data can be stored in a step S3 before further processing and/or preparation of the data. In steps S5 to S8, the data can be processed depending on the user's requirements and/or managed by the user and/or used in different user-specific applications. This means that the user has access to the data and can use it in different applications. For example, several users (S8) and/or the data of several current collectors, several rail vehicles or several trains can be managed (S5). For this purpose, various evaluation, sorting and/or classification suggestions or services can be offered to the user as part of so-called asset services (S6). Following a data service (S7), different data models can be made available to the user according to their requirements. The user receives secure access to the applications S5 to S8 via the access gateway 111.

1. A method for operating a current collector (10, 33) disposed on a roof (11, 34) of a rail vehicle (31) and configured to transmit power from a catenary wire (16, 25, 35) of a catenary to the rail vehicle (31), the current collector (10, 33) comprising a positioning device (13, 56) having a contact strip (14, 17, 27) disposed thereon, the positioning device (13, 56) moving the contact strip (14, 17, 27) relative to the catenary wire and pressing it against the catenary wire in a sliding contact position using a pressing force in order to form a sliding contact, a drive element (73) or a spring element (74) of the positioning device generating the pressing force to the contact strip, wherein the current collector has a power supply unit (50) disposed on the positioning device (13, 56) and a measuring unit (36, 43, 53, 58) having a measuring device (38, 44, 59), at least two sensors (47, 48) of a sensor element (46) of the measuring device being disposed on the positioning device or the contact strip, and the power supply unit (50) yielding at least the electric energy required for supplying power to the sensors of the sensor element, and the sensors each registering measured values in the sliding contact position, a processing element (37, 49) of the measuring device processing the measured values, the processing element correlating the measured values to each other and determining a characteristic value describing an operating state of the current collector or the catenary.

2. The method according to claim 1, wherein a first power supply element (75) of the power supply unit (50) yields the electric energy required for supplying power to the sensors (47, 48) of the sensor element (46) by means of an alternating current applied to the current collector (10) or a second power supply element (76) of the power supply unit (50) yields the electric energy required for supplying power to the sensors (47, 48) of the sensor element (46) by means of a direct current applied to the current collector (10).

3. The method according to claim 1, wherein an angular position of the positioning device (13, 56), an acceleration, a frequency, a temperature, an illuminance, a force, an electric current, a voltage, an electric resistance, a distance, a mass, an air pressure, acoustic noise, wear or a local position are continuously or discontinuously registered and processed as measured values.

4. The method according to claim 1, wherein at least an acceleration sensor is used as a sensor (47, 48), the acceleration sensor being disposed on the contact strip (14, 17, 27) or the positioning device (13, 56).

5. The method according to claim 1, wherein at least one sensor (47, 48) is used which is disposed within the contact strip (14, 17, 27), on the contract strip, on a fastening bearing (21) of the contact strip or on a rocker element (15) of the positioning device (13, 56) holding the contact strip.

6. The method according to claim 1, wherein the positioning device (13, 56) has a rocker element (15) holding the contact strip (14, 17, 27) and a base frame (71) disposed on the rail vehicle and an articulated element (72) disposed between the base frame (71) and the rocker element (15), at least one sensor (47, 48) disposed on the rocker element (15) being used and at least one power supply unit (50) disposed on the articulated element (72) or the base frame (71) being used.

7. The method according to claim 1, wherein the positioning device (13, 56) has a rocker element (15) holding the contact strip (14, 17, 27) and a base frame (71) disposed on the rail vehicle and an articulated element (72) disposed between the base frame (71) and the rocker element (15), the measured values of at least two sensors (47, 48) being transmitted, preferably in a wired manner, to a data-concentrator element (77) disposed on the articulated element (72) or the rocker element (15) and configured for data concentration.

8. The method according to claim 1, wherein the voltage applied to an electric line (78) of the current collector (10, 33) or the electric current is measured in an electric line (78) of the current collector (10, 33) by means of at least one sensor of a base unit (80) of the measuring unit (36, 44, 53, 58) disposed on the base frame (71).

9. The method according to claim 1, wherein the pressure of a pressure line (79) of the positioning device (13, 56) is measured by means of a pressure sensor (81) disposed on the base frame (71), in particular by means of at least one pressure sensor (81) of a base unit (80) of the measuring unit (36, 43, 53, 58) disposed on the base frame (71).

10. The method according to claim 1, wherein the processing element (37, 49) performs an analysis of the measured values while the contact strip (14, 17, 27) is guided along the catenary wire (16, 25, 35) or the processing element (37, 49) registers and stores the measured values of the sensors (47, 48) or the characteristic values in regular temporal intervals, upon change or continuously.

11. (canceled)

12. The method according to claim 1, wherein a control device (54) of the measuring device (38, 44, 59) controls an actuator for actuating the positioning device (13, 56), the actuation of the positioning device being regulated by means of a regulation element (55) of the control device in accord with a measured value or a characteristic value.

13. The method according to claim 11, wherein the pressing force is regulated by the regulation element (55) as a function of the measured values or the characteristic values.

14. The method according to claim 1, wherein the measuring device (38, 44, 59) transmits the measured values or the characteristic values to an evaluation unit (39, 45, 64), the measured values or characteristic values being stored in a databank (51, 65) of the evaluation unit or being processed by means of an evaluation device (52) of the evaluation unit.

15. (canceled)

16. (canceled)

17. (canceled)

18. The method according to claim 13, wherein a user unit (68) forms a data connection (40, 62, 63, 67, 69, 70) to the evaluation unit (39, 45, 64) or to the measuring unit (36, 43, 53, 58), the measured values or the characteristic values being transmitted and output to the user unit.

19. The method according to any one of the claim 13, wherein the processing element (37, 49) or the evaluation unit (39, 45, 64) evaluates a temporal sequence of the measured values or the characteristic values and determines a wear state of the current collector (10, 33) or the catenary while taking into account a time-dependent component relevant for the wear or a component dependent on the measured variable.

20. The method according to claim 13, wherein the sensor element (46) registers a vibration of the contact strip (14, 17, 27), the processing element (37, 49) or the evaluation unit (39, 45, 64) determining a wear state of the contact strip or the catenary.

21. The method according to any one of the claim 13, wherein the processing element (37, 49) or the evaluation unit (39, 45, 64) determines a light arc on the contact strip (14, 17, 27) or the catenary wire (16, 25, 35), a zigzagging catenary wire, an icing of the catenary wire or defects of the catenary wire as an operating state.

22. The method according to any one of the claim 13, wherein the processing element (37, 49) or the evaluation unit (39, 45, 64) performs a sample analysis or statistical evaluation of the measured values stored over a period of time or characteristic values and derives a characteristic number from the sample analysis or the statistical evaluation.

23. The method according to claim 13, wherein the processing element (37, 49) or the evaluation unit (39, 45, 64) correlates the measured values of different sensors (47, 48) or characteristic values to each other and derives functional dependencies of the measured values or characteristic values by means of artificial intelligence.

24. The method according to claim 13, wherein a position sensor of the sensor element (46) determines a local position of the current collector (10, 33), the local position being assigned to the characteristic values or the measured values of another sensor (47, 48) of the sensor element, the evaluation unit (39, 45, 64) determining a state of the catenary.

25. The method according to claim 13, wherein the evaluation unit (39, 45, 64) generates a data model of the catenary along at least a track section of a route (26) of the rail vehicle (31), the data model comprising a plurality of different local positions of the track section, which each have assigned measured values or characteristic values.

26. (canceled)

27. (canceled)

28. The method according to claim 1, wherein the characteristic value is determined during operation of the rail vehicle (31) when the current collector (14, 17, 27) abuts against the catenary wire (16, 25, 35), the characteristic value being determined alternatively or additionally during a stationary operation of the rail vehicle, the current collector being positioned in a rest position or being moved between a contact position against the catenary wire and the rest position on the rail vehicle.

29. A current collector (10, 33), the current collector being disposed on a roof (11, 34) of a rail vehicle and being configured for transmitting power from a catenary wire (16, 25, 35) of a catenary to the rail vehicle, the current collector comprising a positioning device (13, 56) having a contact strip (14, 17, 27) disposed thereon, the positioning device being designed such that the positioning device moves the contact strip relative to the catenary wire and presses it against the catenary wire to a sliding contact position using a pressing force in order to form a sliding contact, the positioning device having a drive element or a spring element by means of which the pressing force to the contact strip is generated, wherein the current collector has a power supply unit (50) disposed on the current collector and a measuring unit (36, 43, 53, 58) having a measuring device (38, 44, 59), at least two sensors (47, 48) of a sensor element (46) of the measuring device being disposed on the positioning device or the contact strip, the sensors each registering measured values in the sliding contact position, the power supply unit (50) yielding at least the electric energy required for supplying power to the sensors (47, 48) of the sensor element (46), and a processing element (37, 49) of the measuring device processing the measured values, the processing element correlating the measured values to each other and determining a characteristic value describing an operating state of the current collector or the catenary.

30. (canceled)

31. (canceled)

32. (canceled)

33. A monitoring system (30) having a plurality of rail vehicles (31) which each have at least one current collector (10, 33) according to claim 24, the monitoring system comprising an evaluation unit (39, 45, 64) for processing measured values or characteristic values of the measuring units (36, 43, 54, 58) of several current collectors.
